(19) United States
(12) Patent Application Publication
(10) Pub. No.: US 2016/0256356 A1
(43) Pub. Date: Sep. 8, 2016

(54) Time and Volume Restricted Liquid Dispenser

(71) Applicant: AlcoLok, Cameron Park, CA (US)

(72) Inventor: Thomas Daniel Hood, Cameron Park, CA (US)

(21) Appl. No.: 15/061,460

(22) Filed: Mar. 4, 2016

Related U.S. Application Data
(60) Provisional application No. 62/129,579, filed on Mar. 6, 2015.

(51) Int. Cl. A61J 7/04; B67D 7/30; B67D 7/34; B67D 7/22

(52) U.S. Cl. CPC A61J 7/04; B67D 7/221; B67D 7/302; B67D 7/34; A61J 2200/30

(57) ABSTRACT

A liquid dispensing apparatus includes a tank that includes an opening configured to receive a liquid. The apparatus includes a dispense valve configured to dispense the liquid. The apparatus further includes a touchpad input device configured to receive an input from a user and a liquid dispensing controller configured to determine a dispense rate for dispensing the liquid based on the input received from the user. The apparatus, via the dispense valve, is configured to dispense the liquid at a first dispense rate for a first period of time when a level of the liquid in the tank falls below a first tank level to dispense a first amount of the liquid and to dispense the liquid at a second, different dispense rate for a second period of time when the level of the liquid falls below a second tank level to dispense the first amount of the liquid.

### RELATED APPLICATION

This patent application claims priority under 35 USC §119(e) to Provisional Patent Application No. 62/129,579 filed on Mar. 6, 2015, which is incorporated by reference herein in its entirety.

### TECHNICAL FIELD

This disclosure relates to an apparatus for dispensing liquids, in particular, to an apparatus for dispensing liquids based on time and volume.

### BACKGROUND

Many people face substance abuse problems. In order to combat substance abuse, individuals often try to quit ingesting the substance cold-turkey. However, individuals may not succeed in controlling substance abuse when taking such drastic measures to reduce their dependency upon a substance.

Some people have a difficult time controlling their intake of alcohol. Some people may wish to control the amount of alcohol they consume as well as the speed at which the alcohol is consumed (e.g., amount of drinks per hour).

Moreover, other substances such as prescription cough syrups or opioid-dependency treatment drugs, such as Methadone, should be administrated in a controlled manner. People who consume more than the prescribed amount of such drugs may potentially overdose on them.

### BRIEF DESCRIPTION OF THE DRAWINGS

The present disclosure is illustrated by way of example, and not by way of limitation, in the figures of the accompanying drawings, in which:

FIG. 1A illustrates an exemplary liquid dispenser in accordance with an implementation of the disclosure;

FIG. 1B illustrates a back view of an exemplary touchpad input device including a ribbon in accordance with an implementation of the disclosure.

FIG. 1C illustrates a front view of an exemplary touchpad input device in accordance with an implementation of the disclosure.

FIG. 2A illustrates a top view of an exemplary liquid dispenser in accordance with an implementation of the disclosure.

FIG. 2B illustrates a bottom view of an exemplary liquid dispenser in accordance with an implementation of the disclosure.

FIG. 3A illustrates a back view of an exemplary liquid dispenser in accordance with an implementation of the disclosure.

FIG. 3B illustrates a front view of an exemplary liquid dispenser in accordance with an implementation of the disclosure.

FIG. 4 illustrates a side view of an exemplary liquid dispenser in accordance with an implementation of the disclosure.

FIG. 5 illustrates a front cross-sectional view of an exemplary liquid dispenser in accordance with an implementation of the disclosure.

FIG. 6 illustrates a back cross-sectional view of an exemplary liquid dispenser in accordance with an implementation of the disclosure.

FIG. 7 illustrates a side view of an exemplary tank including tank level indicators in accordance with an implementation of the disclosure.

FIG. 8 illustrates an exemplary tank in accordance with an implementation of the disclosure.

FIG. 9 illustrates the schematics of an exemplary liquid dispenser including an exemplary liquid dispensing controller in accordance with an implementation of the disclosure.

FIG. 10 is a flow diagram illustrating a method for providing a dispense rate based on a tank level according to an implementation of the disclosure.

FIG. 11 is a block diagram illustrating an exemplary computer system in accordance with an implementation of the disclosure.

### DETAILED DESCRIPTION

Aspects and implementations of the present disclosure are directed to a liquid dispenser. The liquid dispenser includes a tank that holds and dispenses a liquid. The tank includes an opening to receive the liquid. The opening may include a fill valve on the other end. The fill valve may be used to fill the tank with the liquid. A dispense valve located on the bottom of the tank may be used to dispense the liquid out of the tank. The liquid dispenser also includes a touchpad input device that receives an input from a user. The liquid dispenser includes a liquid dispensing controller that determines a dispense rate for dispensing the liquid based on the input received from the user. The liquid dispenser, via the dispense valve, dispenses the liquid at a first dispense rate for a period of time when a level of the liquid falls below a first tank level to dispense a first amount of the liquid. The liquid dispenser, via the dispense valve, dispenses the liquid at a second dispense rate for a second period of time when the level falls below a second tank level to dispense the first amount of the liquid. The first dispense rate is different than the second dispense rate. A user may program the liquid dispenser to dispense a liquid such as alcohol in a time and volume controlled manner.

Previous solutions for controlling or limiting intake of a substance may not work for a person as he/she may try to control his/her intake, but may lose the willpower to limit himself/herself and instead ingest the substance. Implementations of the disclosure address the shortcomings of a user manually controlling intake of a substance by using a liquid dispenser. The liquid dispenser limits the intake in a manner that limits a user's substance intake and provides access to the substance in a controlled manner.

The term liquid as used herein applies to any type of liquid including a controlled substance, a prescription medication, an alcoholic substance, a beverage having high sugar content or a high calorie beverage, or any other liquid. After the liquid is dispensed, the liquid may be consumed by a user orally, intravenously, etc.

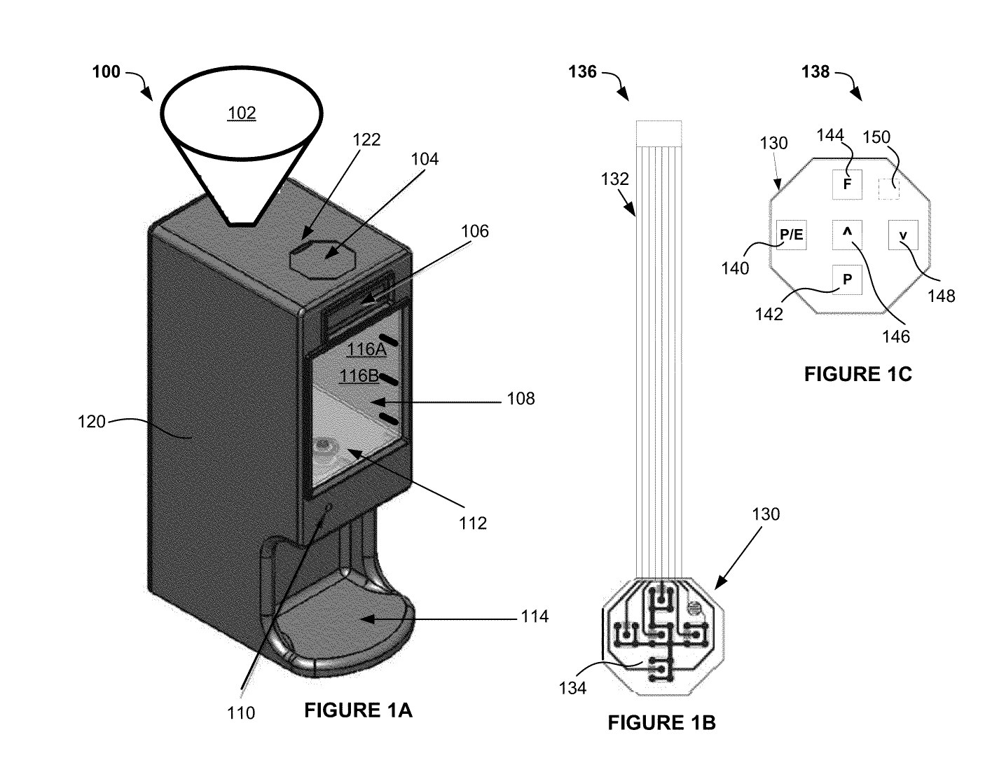

FIG. 1A illustrates an exemplary liquid dispenser 100 in accordance with an implementation of the disclosure. Liquid dispenser 100 includes a housing 120. The housing 120 has an opening on top where a funnel 102 may attach. A liquid may be dispensed into the opening. For example, a user may pour the liquid into the opening or the opening may receive the liquid by other means. In an implementation, the funnel 102 may be permanently affixed to the housing 120. In another implementation, the funnel 102 may be removable and not permanently affixed to the housing 120. A cover (not shown) may be placed on the funnel 102 or the opening on top of the housing 120.

The housing 120 also includes a touchpad recess 104, a display device 106, a tank 108, an indicator light 110, a dispense valve 112, and a cavity base 114. The dispense valve 112 may be coupled to the housing 120 and the tank 108. In an implementation, a portion of the dispense valve 112 may be affixed to or otherwise attached to a bottom portion of the tank 108. The tank 108 includes tank level indicators 116A and 116B.

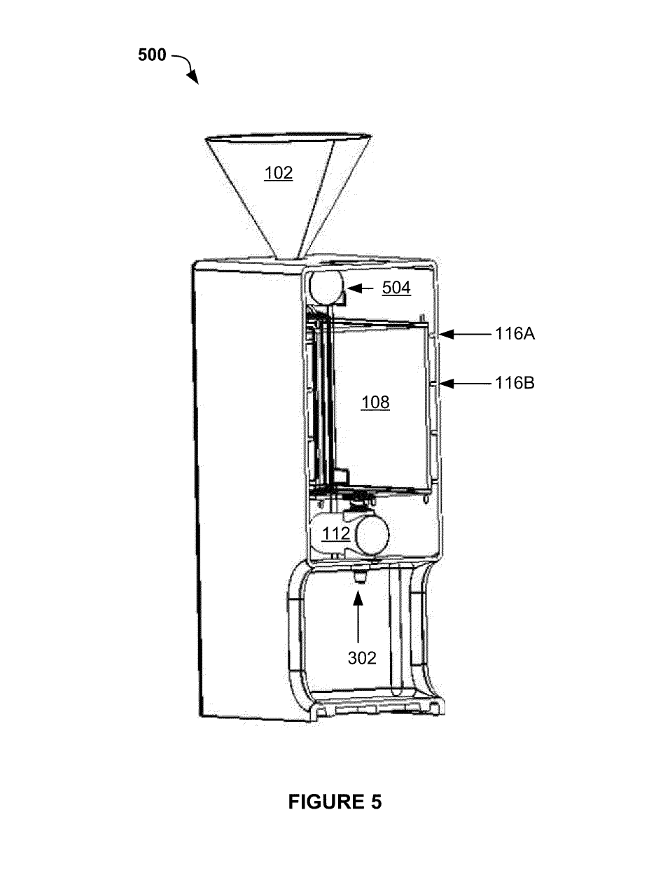

The funnel 102 may extend into the opening to attach to a fill valve (described herein with respect to FIG. 5) and attach to the fill valve via a rubber o-ring for sealing. The fill valve may be located on top of the tank 108 and underneath the opening of the housing 120. In an implementation, a portion of the fill valve may be affixed to or otherwise attached to a top portion of the tank 108. In an implementation, the funnel 102 may include national pipe threads (NPT) that may be tapered such that the further the funnel 102 is threaded into the opening of the housing 120, the more the funnel 102 binds to the fill valve (and vice versa). In an implementation, the threads of the fill valve may be standard quarter-inch female national pipe threads (FNPT). In an implementation, the threads on the funnel 102 may be two-thirds as long as the standard quarter-inch male national pipe threads (MNPT) on the fill valve. In an implementation, a larger portion of quarter-inch MNPT on the funnel 102 may not be used so that a user may thread the funnel 102 onto the valve with no binding. When the funnel 102 is threaded on the fill valve, the funnel 102 may stop when the bottom tip of the funnel 102 reaches the o-ring. The o-ring may be bound to a flat surface of the fill valve to prevent leaking while filling the tank 108.

In some implementations, the dispense valve 112 and/or a fill valve (described herein with respect to FIG. 5) may be solenoid valves. In an implementation, the valves may be 12-volt direct current (vdc) normally closed solenoid valves.

When a user wishes to fill the liquid dispenser 100 with a liquid, the user may select a button (i.e., a fill button) that opens a solenoid in the fill valve in tank 108. The solenoid may be controlled based on input provided by the user (e.g., the user selecting the fill button). The solenoid may be opened or closed. Details regarding the fill button are described herein below with respect to FIG. 1C. When the solenoid in the fill valve is open, a user may pour the liquid into the tank 108, via funnel 102.

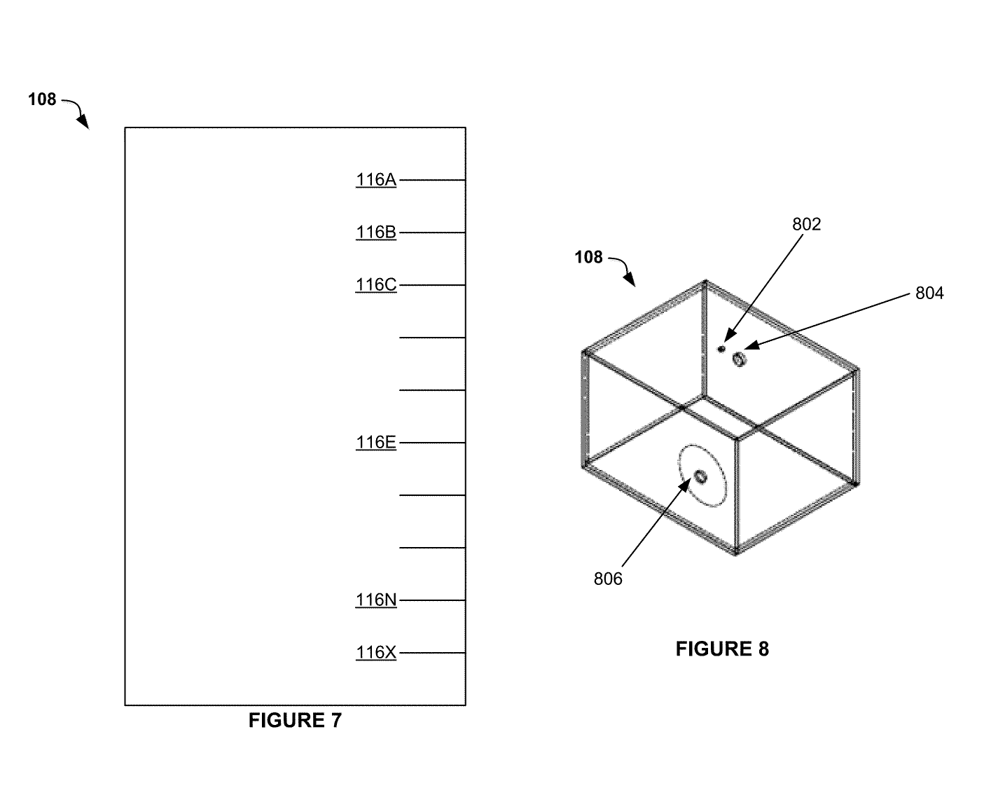

After the liquid has been poured into tank 108, the top level of the liquid may fall on or above a tank level indicator. The tank 108 includes multiple tank level indicators (e.g., 116A, 116B). The tank level indicators may divide the tank 108 into equal partitions. For example, there may be ten tank level indicators that divide the tank 108 into ten equal partitions. In an implementation, an external coating or sticker(s) (e.g., vinyl sticker) that mark the tank level indicators may be affixed to one or more sides of the tank 108. In another implementation, the tank level indicators may be etched onto the tank 108. In other implementations, tank level indicators may be placed on the tank 108 by other means. More or less tank level indicators than depicted in FIG. 1A may be included. FIG. 7 described below provides additional details regarding the tank level indicators.

After the user pours the liquid into the tank 108, the user may provide an input to the liquid dispenser 100 (via a touchpad input device) to manually specify the tank level indicator under which the liquid falls. For example, when a liquid is poured into tank 108, the top level of the liquid may reach tank level indicator 116A. The user may observe that the liquid falls at or below tank level indicator 116A. The user may provide an input to the touchpad input device that indicates the tank level indicator is tank level indicator 116A. In another example, if a liquid falls in between tank level indicators, the user may select the tank level indicator directly above or below the top level of the liquid. In an implementation, the user may select the tank level indictor below the top level of the liquid. For example, if a top level of a liquid falls between the tank level indicators 116A and 116B, the user may input tank level indicator 116B into the liquid dispenser 100.

The user may provide an input using a touchpad input device (such as a keypad, keyboard, etc.). The touchpad recess 104 provides a shallow housing where a touchpad input device may be affixed. The touchpad input device may affix to the touchpad recess 104 by glue or other adhesive. FIG. 1B illustrates a back view 136 of an exemplary touchpad input device 130 including a ribbon 132 in accordance with an implementation of the disclosure. Touchpad input device 130 includes circuitry 134 for touchpad buttons/keys (illustrated in FIG. 1C). The ribbon 132 includes wiring that connects the circuitry 134 with the top of the ribbon (which may include pins). The top of ribbon 132 may be inserted into touchpad slot 122 in FIG. 1A. The ribbon 132 in FIG. 1B may be affixed to (snap on to or otherwise attach to) circuitry of display device 106 in FIG. 1A in order to provide input to display device 106. Therefore, touchpad input device 130 may be coupled to display device 106. Although the touchpad input device 130 is shown as being detached from the liquid dispenser 100, in other implementations, touchpad input device 130 may be affixed to liquid dispenser 100.

Display device 106 may provide a textual and/or a graphical display output displayed to a user. In an implementation, the display device 106 may be a liquid crystal display (LCD) or a touch screen that provides at least sixteen characters and two lines. In other implementations, other types of display devices may be used.

A user may provide input to liquid dispenser 100 and the display device 106 in FIG. 1A by the depressing or otherwise selecting keys of the touchpad input device 130. FIG. 1C illustrates a front view 138 of an exemplary touchpad input device 130 in accordance with an implementation of the disclosure. Touchpad input device 130 includes a program/enter button (P/E) 140, a pour button (P) 142, a fill button (F) 144, an up arrow button 146, and a down arrow button 148. A ghost button 150 may also be included. In an implementation, the ghost button 150 may be invisible. The ghost button 150 may be depressed by a user that wishes to select functionality provided by the ghost button 150. The functionality may include calibration of the liquid dispenser 100 or reconfiguration or resetting of default settings.

As described above, to open the solenoid in the fill valve and pour a liquid into tank 108, a user may select (i.e., by depressing or other means of selecting) the fill button 144. Once the fill button 144 is selected, the user is provided with a limited time period to fill the tank 108. For example, a user may be given two minutes to fill the tank and a solenoid in the fill valve may remain open for two minutes. The user may then pour the liquid into the tank 108, via funnel 102. In an implementation, a timer may be set for a limited period of time such that upon the expiration of the timer, the solenoid in the fill valve closes. In an implementation, the display device 106 may provide a numerical countdown of the timer so that the user can see when the timer expires. In another implementation, a sound (e.g., a chime, etc.) may be played to inform the user that the timer has expired. When the timer has expired, if the user wishes to pour more liquid into the liquid dispenser 100, the user may open the solenoid in the fill valve again by selecting the fill button 144.

When the user selects the fill button 144, the display device 106 may display the following: “After filling, press enter key.” If the user finishes filling the tank 108 before the expiration of the timer, the user may close the solenoid by selecting the program/enter button 140.

Once the timer expires or the program/enter button 140 is selected, the solenoid in the fill valve closes. After the solenoid is closed, the display device 106 may display the following: “Enter new tank level.” The user may then input the tank level based on the tank level indicator that is closest to (or above or below) the top level of the liquid. For example, if a top level of the liquid falls at or above the tank level indicator 116B, the user may visually observe that the liquid level is closest to the tank level indicator 116B and enter the tank level indicator 116B into the touchpad input device 130. As described above, the tank may be divided into ten tank levels. Tank level indicator 116B may correspond to tank level nine. The user may input the tank level into to the touchpad input device 130. In an implementation, the display device 106 may list the number “10” on the display after querying the user to enter a new tank level. The user may select the down arrow button 148 until the number “9” is displayed on the display device 106. The user may then select the program/enter button 140. The display device 106 may display the following: “Tank level set.” The display device 106 may return to a standby mode. In a standby mode, the display device 106 may provide a current date/time or a blank screen.

The user may use the pour button 142 to dispense the liquid. In an implementation, the pour button 142 may only be activated if dispensing is available. Dispensing may be available when the liquid dispenser 100 is operating in a manual mode. Dispensing may or may not be available when the liquid dispenser 100 is operating in a free flow mode or a regulated mode. In a manual mode, a user may freely dispense any amount of the liquid without restrictions. In a free flow mode, certain restrictions may be placed. In a free flow mode, a certain amount of the liquid per pour may be restricted (e.g., two ounces may be dispensed in a single pour) but there may not be a restriction on the amount of pours/drinks (e.g., unlimited amount of two ounce pours may be dispensed) or time restrictions. In a regulated mode, the amount of the liquid that can be dispensed may be restricted in view of time and volume restrictions. For example, in a regulated mode, the amount of the liquid that can be dispensed may be restricted in view of a particular time (e.g., the liquid may be dispensed between the hours of 5:00 PM and 7:00 PM) and/or a particular volume (a particular amount, e.g., eight ounces).

In an implementation, to prevent tampering, a mercury switch may be included in the fill valve. If a user selects a fill button 142 and attempts to turn the liquid dispenser 100 upside down and attempt to pour the liquid out, the mercury switch may prevent the contents of the liquid from being poured out. Therefore, the liquid dispenser 100 may be siphon-protected by the mercury switch which prevents the liquid from being poured out from the top of the tank 108.

A user may program the liquid dispenser 100 to dispense liquid in a restricted or controlled manner in a regulated mode. To enter a regulated mode, a user may select the program/enter button 140 on the touchpad input device 130. After selection of the program/enter button 140, the display device 106 may display the following: “Regulate liquid dispenser?” A flashing default text displaying “No” may be provided. The user may scroll using the up arrow button 146 and down arrow button 148 to toggle the “No” selection to “Yes.”

Once the “No” selection is provided on the display device 106, the user may select the program/enter button 140 to enter the selection. The liquid dispenser 100 enters a free flow mode. Next, the display device 106 may display the following: “Amount per pour?” In another implementation, the amount may be displayed as ounces, milliliters, etc. The display device 106 may alternatively display “Ounces per shot?” The display device 106 may provide a list of selections on a next line. For example, the display device 106 may display the following: “0.5, 1, 1.5, 2, 2.5, 3, 4, 5, and 6.” The user may use the up arrow button 146 and down arrow button 148 to select one of the numbers displayed on the display device 106. After the selection is made, the user may select the program/enter button 140 to store the desired selection. The display device 106 may then return to a standby mode.

When the liquid dispenser 100 is in a free flow mode, the liquid may be dispensed without restriction on a total amount of liquid that may be dispensed in a time period. When a user wishes to dispense the liquid, the user may place a glass or other container on the cavity base 114 and select the pour button 142. When the pour button 142 is selected, the indicator light 110 may turn green (indicating that dispensing of the liquid is available). A light may also illuminate the cavity base 114 where the glass is placed. The user may then dispense the liquid. If the user wishes to dispense additional liquid, the user may select the pour button 142 again and dispense an additional amount of the liquid. If the user has selected to dispense half an ounce each time the pour button 142 is selected, half an ounce of the liquid will be dispensed each time the user selects the pour button 142.

When a user wishes to enter a regulated mode, when the display device 106 displays the following: “Regulate liquid dispenser?” the user may select “Yes.” The user may select “Yes” in a similar manner as the user selected “No” described above with respect to the free flow mode. The display device 106 may display the following on a first line of the display: “Enter start hour.” The display device 106 may also display on a second line an hour (i.e., 12). The user may use the up arrow button 146 and down arrow button 148 to select a desired hour. In an implementation, the hour may be provided in military time (i.e., ranging from 0 hours to 2300 hours). The display device 106 may then display “Enter start minute.” The user may scroll and select the start minute using the up arrow button 146 and down arrow button 148 in a manner similar to the manner described above with the selection of the start hour. The display device 106 may then display the following: “Enter stop hour.” The user may scroll and select the stop hour using the up arrow button 146 and down arrow button 148 in a manner similar to the manner described above with the selection of the start hour. The display device 106 may then display the following: “Enter stop minute.” The user may scroll and select the stop minute using the up arrow button 146 and down arrow button 148 in a manner similar to the manner described above with the selection of the start minute. The time input may be compared with an internal clock to allow dispensing of the liquid at certain programmed times. The internal clock may use an electrically erasable programmable read-only memory (EEPROM) or other memory.

The display device 106 may then display the following: “Enter # of pours per day.” In an implementation, if the number of pours is in shots, the display may display “Enter shots per day.” The user may select a number of pours per day in a manner similar to manner described above with respect to the selection of the amount per pour in a free flow mode.

The display device 106 may then display the following: “Select days to regulate.” The user may select a number of days to regulate (for example, from one to thirty days) in a manner similar to the manner described above with respect to the selection of pours per day.

The display device 106 may then display the following: “Allow early pour?” The user may select “Yes” or “No” to allow early pour in a manner described above with respect to other yes or no queries. When early pour is allowed, a user may dispense one, two, or all of the liquid allocated to a time period at any time during the time period. The time period dispensing is available is also referred to as a dispensing time window. For example, suppose a user wishes to dispense two drinks between the hours of 5:00 PM and 7:00 PM. If the user enables early pour by selecting “yes” the user may dispense a first drink at 5:01 PM and a second drink at 5:02 PM.

If, however, the user selects “no” and does not wish to allow early pour, the dispensing of drinks may be time-controlled and paced. For example, if a user wishes to dispense two drinks between the hours of 5:00 PM and 7:00 PM and does not allow early pour, the first drink may be dispensed any time between 5:00 PM and 7:00 PM and the next drink may dispensed after sixty minutes of dispensing the first drink. If the user dispenses a first drink at 6:50 PM, the user may not dispense a second drink as sixty minutes after 6:50 PM is 7:50 PM (which falls outside the allotted dispensing time window between 5:00 PM and 7:00 PM). Therefore, the two drinks entered by the user in the regulated mode are a maximum number of drinks that may be dispensed in the dispensing time window.

The user may be alerted that the liquid dispenser 100 is ready for dispensing when the indicator light 110 turns green. In order to dispense a drink, the user may select the pour button 142 to dispense the drink. In an implementation, if the indicator light 110 is green and the user selects the pour button 142, the drink may be dispensed out of the liquid dispenser 100 with little or no delay after the user selects the pour button 142.

In another implementation, if the drink is available for dispensing as a result of early pour being enabled (i.e., when the user has enabled early pour during programming), the user may select the pour button 142 for a predetermined period of time (e.g., 2 seconds) before the drink is dispensed. In an implementation, the indicator light 110 may not turn green when a drink is available for early pour dispensing as a result of early pour being enabled. In another implementation, the indicator light 110 may turn green when a drink is available for early pour dispensing.

In an implementation, the indicator light 110 may turn green if the current time of day is within a dispensing time window and liquid may be dispensed. As described above, the dispensing time window is a time frame that is selected by a user in a regulated mode to dispense a liquid. When liquid is not available for dispensing, the indicator light 110 may not be activated (i.e., may be turned off). The liquid may not be available for dispensing if the pouring of the liquid is unavailable (e.g., due to a time restriction and/or due to a pour/drink restriction). In another implementation, the indicator light 110 may instead turn a different color (e.g., red) when the liquid is not available for dispensing and then turn green when the liquid is available for dispensing. In an implementation, the display device 106 may provide for display an indication of whether the liquid is available for dispensing.

In the above example where a user selects two drinks to be dispensed within the dispensing time window of 5:00 PM to 7:00 PM, the indicator light 110 may turn green at 5:00 PM to indicate that the liquid may be dispensed. If no liquid is dispensed by 7:00 PM (or one out of two maximum drinks are dispensed), the indicator light 110 may turn off.

As described above, when the pour button 142 is selected by a user, the solenoid in the fill valve opens. When the solenoid opens, a command/signal is sent to the indicator light 110 to turn off and a timer used for dispensing the liquid is adjusted in view of the dispensing of the liquid. For example, if a maximum of six total drinks may be dispensed (and one drink may be dispensed every hour because early pour is turned off) from 5:00 PM to 10:00 PM, after a first drink is dispensed (and other drinks are available for dispensing in the next hour), the timer is adjusted to count down to the next hour. When the timer expires, the indicator light 110 may turn green again to indicate that a drink may be dispensed.

In an implementation, the time remaining before the timer used for dispensing the liquid expires may be provided on the display device 106. If the maximum drinks for one day have been dispensed, the display device 106 may display the time when the next drink is available on the next day (e.g., the display device 106 may display the following: “23:15 minutes remain until the next pour.”).

The user may use the up arrow button 146 and down arrow button 148 to input information or increment or decrement a number, time or date provided on display device 106. For example, if display device 106 displays a query to the user to enter a number of drinks to dispense in a period, the display device 106 may provide a number “1”. If the user wishes to enter two drinks, the user may select the up arrow button 146 to increment the number one to two. In an alternative implementation, the user may enter a number into the touchpad input device 130 using a keypad or keyboard (not depicted).

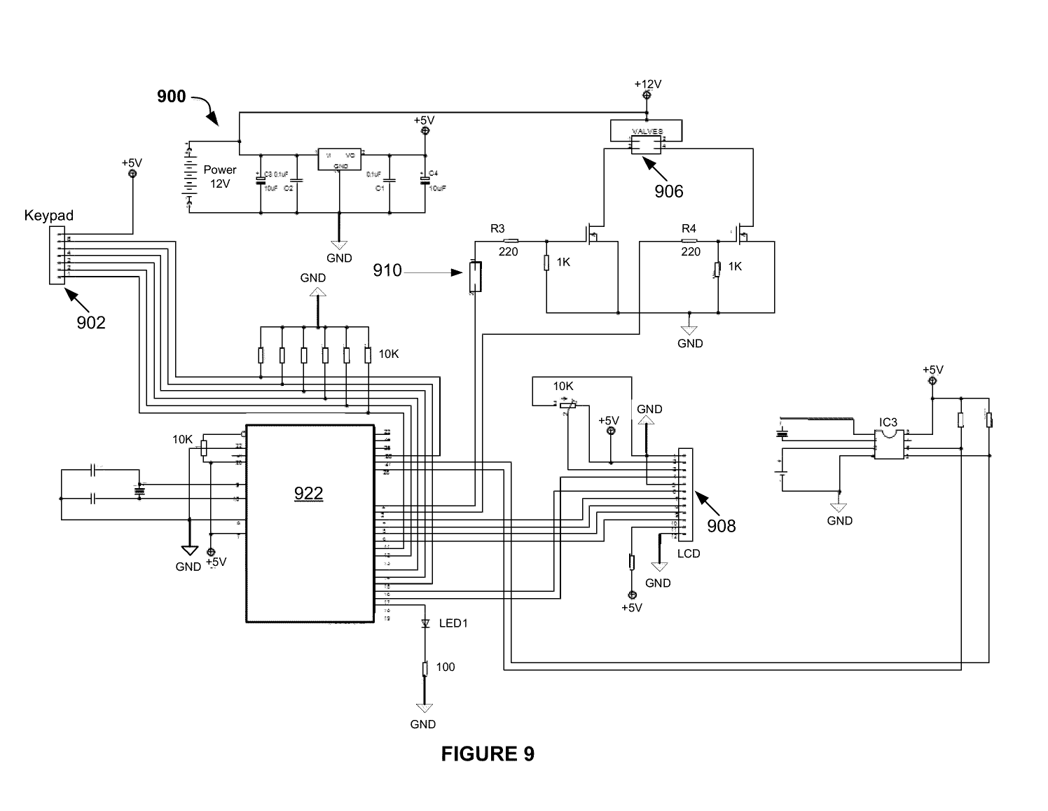

The program/enter button 140 may be used to begin programming of the liquid dispenser 100 (to enter a regulated mode, a free flow mode or a manual mode). The programming of the liquid dispenser 100 may be performed by a processing device in a liquid dispenser controller that is coupled to the liquid dispenser 100. Details regarding the liquid dispenser controller are described herein with respect to FIG. 9. The program/enter button 140 may also be used select an item displayed on display device 106.

The user may input a current time, date, year, etc. into the display device 106. To set the time, the user may select and hold down the program/enter button 140 for a predetermined amount of time (i.e., five seconds) or until the display device 106 displays the following: “Adjust time of day.” Adjacent to this message or underneath the message, a flashing default text displaying “No” is provided. A user may select the up arrow button 146 and down arrow button 148 to toggle the “No” displayed and instead select “Yes”. After the display device 106 displays the word “Yes” in flashing text, the user may select the program/enter button 140 to lock in the selection. The display device 106 may then display the following: “Adjust hours:”. A current hour (or a default 12:00) may flash on the display. A user may select the up arrow button 146 and down arrow button 148 to scroll to the desired hour then select the program/enter button 140 to store the selected hour. The display device 106 may then display the following: “Adjust minutes:”. Minutes (i.e., a default 00) may flash on the display. A user may select the up arrow button 146 and down arrow button 148 to scroll to the desired minutes then select the program/enter button 140 to store the selected minutes. The display device 106 may then display the following: “Time changed” and return to a standby mode.

In an implementation, the time, date, etc., may be changed if the liquid dispenser 100 is not in a program mode (i.e., a regulated mode). This prevents users attempting to tamper with a program in order to dispense liquid. For example, if a user has to wait until 7:00 PM to dispense a liquid, the user may not reset the clock to display a time after 7:00 PM in order to dispense the liquid. If a user attempts to change the time, date, etc., during a program mode, the display device 106 may display the following: “You need to wait X-days before you can change the time,” where X is the days left until the program mode ends.

A user may securely lock the liquid dispenser 100 (including the display device 106) by setting up a passcode. To set a passcode, the user may select a button on touchpad input device 130. For example, the user may select the up arrow button 146 for a predetermined amount of time (e.g., 5 seconds). The display device 106 may display the following: “Turn security on?” The user may select “Yes” in a manner described above with respect to a “Yes” or a “No” query. If the user selects “No” the display device 106 returns to a standby mode. If the user selects “Yes” and selects the program/enter button 140, the display device 106 may display the following: “How many codes?” The user may select multiple codes (for different users). The display device 106 may display the following: “Enter the 1^{st} code”. The user may select a combination of the buttons on the touchpad input device 130. Each of the codes may be entered in a similar manner.

After the last passcode is entered, the display device 106 may display the following: “Re-enter the first code.” After all of the passcodes have been verified, the display device 106 may display the following: “Security set.” The display device 106 may then return to a standby mode.

In order for a user to input any command into the touchpad input device 130 (including selection of the pour button 142), the user must enter a valid passcode. In an implementation, if a user enters an incorrect passcode a number of times, the user may be penalized. For example, suppose that a user sets a first passcode. If the user (or another user) inputs a second passcode, which is an incorrect passcode and is different than the first passcode, a pour may be removed from the number of pours. As described above, the user may be allowed to input a passcode a number of times before being penalized. For example, a first time that the user enters an incorrect passcode, the display device 106 may display the following: “Mismatch” and then “Try again?” If the user selects “No”, the display device 106 returns to a standby mode. If the user selects “Yes” and then enters an incorrect passcode, one pour (or drink) may be deducted. The display device 106 may display the following “Shot removed” to alert the user that a pour has been deducted. For example, if the user is allowed to dispense three drinks in a dispensing time window, after entering an incorrect passcode more than once, one drink may be deducted from the three drinks each time an incorrect passcode is entered. After a penalty drink has been deducted, the timer is adjusted in a similar manner as when a pour is dispensed.

The security passcode(s) may protect the liquid dispenser 100 from being accessed by unauthorized users (e.g., children, etc.). A user may select to disable the security so that a passcode may not be used.

Dispense valve 112 may dispense a liquid (and thus, the solenoid may be opened) when two conditions are met in a regulated mode. The two conditions are described herein below. Dispense valve 112 may dispense the liquid upon selection of the pour button 142. As described above, a user can be informed that the dispensing of the liquid is available when the indicator light 110 turns green.

The first condition is time-based. When the current time falls within a dispensing time window, the first condition is met.

The second condition is based on a number of pours (e.g., drinks) When a current number of pours has not exceeded the number of pours allotted in the dispensing time window in a regulated mode, the second condition is met. When both conditions are met, the solenoid in the dispense valve 112 (which may normally be closed), may open upon selection of the pour button 142 and the liquid may be dispensed.

The solenoid in the dispense valve 112 may open and dispense freely (without meeting conditions) when the liquid dispenser 100 is in a free flow mode or unregulated mode. If security is activated, regardless of what mode the liquid dispenser 100 is in, the correct passcode is to be provided prior to dispensing.

Although the liquid dispenser 100 is depicted as including five buttons, more or less buttons than depicted may be included. Additionally, more or less ghost buttons than depicted may be included. Further, although the touchpad input device 130 may receive input from a user to provide to the display device 106, in other implementations, other input devices may be used instead of touchpad input device 130. For example, a keyboard, touchscreen or other input device may be used. In other implementations, a user may provide input to display device 106 using a touchscreen liquid crystal display (LCD) included within display device 106, on touchpad recess 104 or elsewhere. A user may provide input to display device 106 using a voice input device or by other means.

In an implementation, the tank 108 is a crystal tank. In other implementations, the tank 108 may be composed of a plastic or other material. The tank 108 may be clear or opaque so that when a liquid is poured into the tank 108, a user can view the contents of the tank 108.

As liquid contained within the tank 108 of the liquid dispenser 100 is dispensed, the top level of the liquid may move down from one tank level indicator to lower tank level indicator. As gravity and pressure affects the rate at which a liquid is dispensed, when there is more liquid in the tank, an amount of the liquid may dispense at a faster rate than when there is less liquid in the tank. Therefore, when a liquid is at a level of a topmost tank level indicator, the liquid will dispense faster than when the liquid is at a level of a bottommost tank level indicator. When the liquid is at the level of the topmost tank level indicator, there is more liquid than when it is at the level of the bottommost tank level indicator. Therefore, when the liquid as at the level of the topmost tank level indicator, the liquid will flow at a faster rate as there is more pressure being exerted on the dispense valve 112.

When the liquid is at the level of the bottommost tank level indicator, the liquid will flow at a slower rate as there is less pressure being exerted on the liquid. Therefore, one ounce of a liquid will flow out at a faster rate when the liquid is at a level of a higher tank level indicator than when the liquid is at a level of a lower tank level indicator. To account for the difference in dispense rates, an amount of liquid may be dispensed for a certain period of time (and have a first dispense rate) when the liquid is at a level of a first tank level indicator. The same amount of liquid may be dispensed for a different period of time (and have a second dispense rate different than the first dispense rate) when the liquid is at a level of a second tank level indicator. For example, to dispense a half an ounce of a liquid when the level of the liquid falls below tank level indicator 116A, it may take two seconds to dispense. To dispense a half an ounce of liquid when the level of the liquid falls below tank level indicator 116B, it may instead take three seconds to dispense. The dispense rate of dispensing the liquid when the level of the liquid falls below tank level indicator 116A may be faster (and thus, the solenoid in the dispense valve 112 may be opened for a shorter period of time) than when the level of the liquid falls below tank level indicator 116B (and thus, the solenoid in the dispense valve 112 may be opened for a longer period of time). FIG. 7 described below provides additional details regarding the tank level indicators.

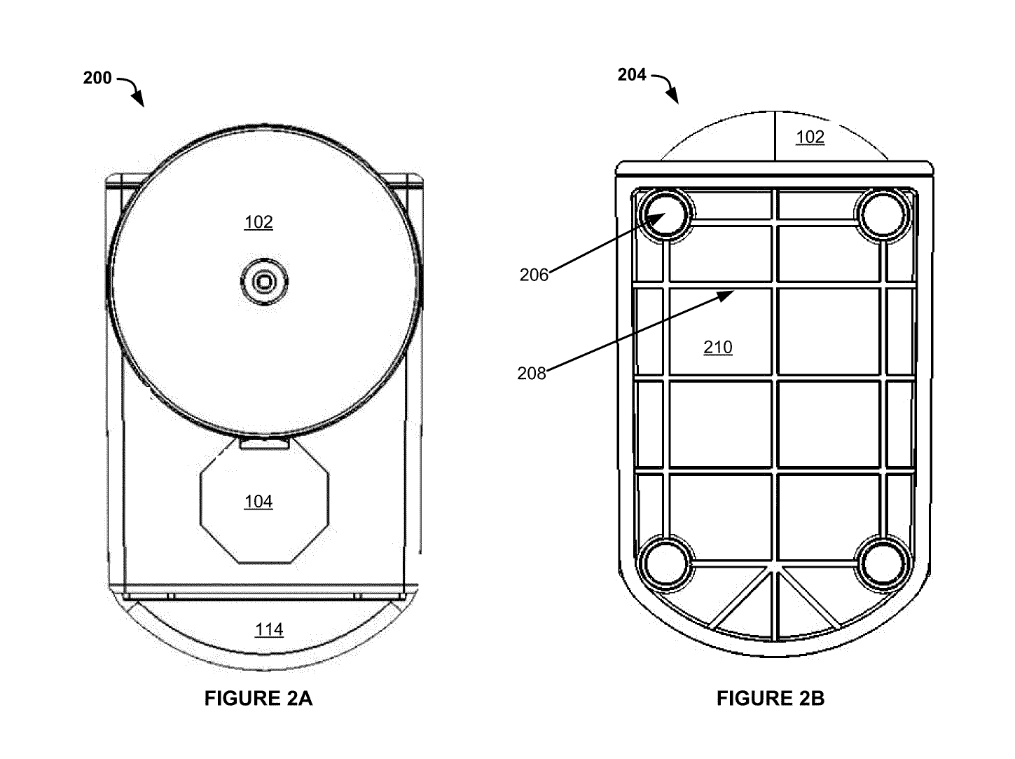

FIG. 2A illustrates a top view 200 of the liquid dispenser 100 in accordance with an implementation of the disclosure. The top view 200 depicts the funnel 102, the touchpad recess 104 and the cavity base 114.

FIG. 2B illustrates a bottom view 204 of the liquid dispenser 100 in accordance with an implementation of the disclosure. The bottom view 204 depicts the bottom of funnel 102, and a liquid dispenser base 210. Liquid dispenser base 210 may include four protectors 206. Protectors 206 may be composed of felt, plastic, rubber or other materials. Protectors 206 may provide non-slip functionality and/or also protect surfaces from being scratched by the liquid dispenser 100. Liquid dispenser base 210 may also include a framework 208 arranged in a lattice-like structure to reinforce the liquid dispenser 100. In an implementation, liquid dispenser base 210 and/or framework 208 may be composed of plastic.

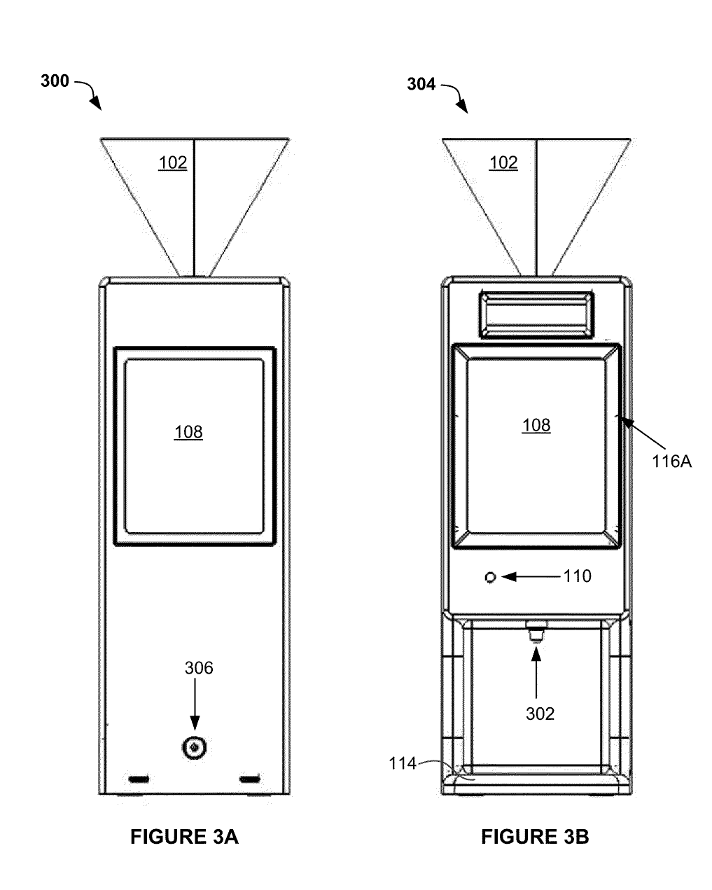

FIG. 3A illustrates a back view 300 of the liquid dispenser 100 in accordance with an implementation of the disclosure. The back view 300 depicts the funnel 102, and the tank 108. An electrical connection outlet 306 may be coupled to a cable that plugs into an electrical socket.

FIG. 3B illustrates a front view 304 of the liquid dispenser 100 in accordance with an implementation of the disclosure. The front view 304 depicts the funnel 102, the tank 108, the indicator light 110, the cavity base 114, and an outlet 302 of the dispense valve 112.

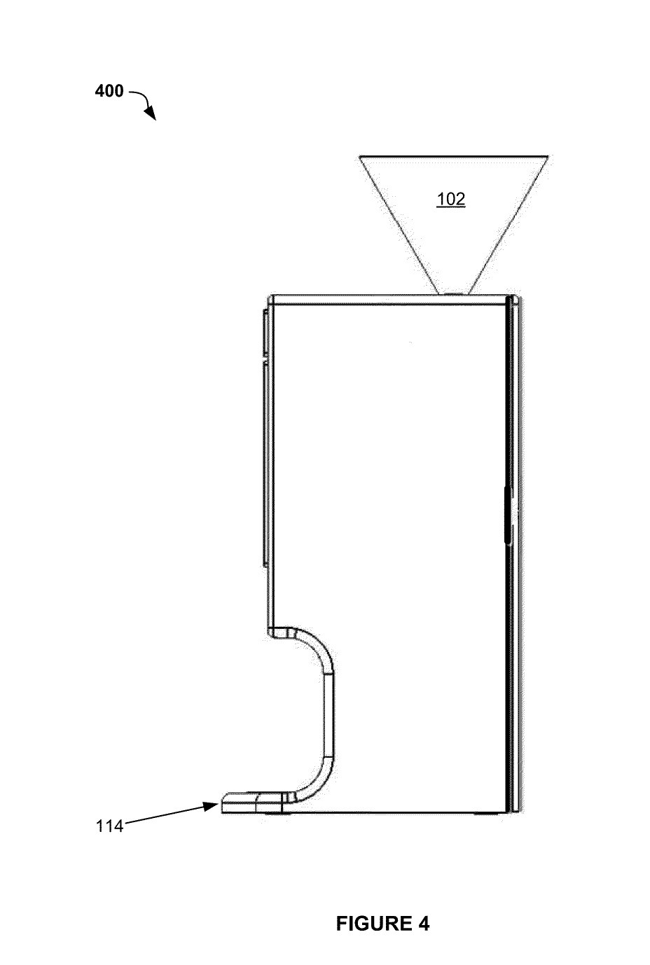

FIG. 4 illustrates a side view 400 of the liquid dispenser 100 in accordance with an implementation of the disclosure. The side view 400 depicts the funnel 102 and the cavity base 114.

FIG. 5 illustrates a front cross-sectional view 500 of the liquid dispenser 100 in accordance with an implementation of the disclosure. The front cross-sectional view 500 depicts a funnel 102, a fill valve 504, the tank 108, the dispense valve 112, and the outlet 302 of the dispense valve 112. The tank 108 also includes tank level indicators 116A and 116B. Dispense valve 112 may be coupled to a bottom part of tank 108.

The fill valve 504 includes a solenoid that may be closed but may be opened upon receiving user input. For example, when the user selects the fill button 144, the solenoid may be opened (for a period of time) to receive the liquid so that the liquid may be poured into the tank 108. The fill valve 504 may be coupled between the funnel 102 and the tank 108. A portion of the fill valve 504 may be housed within the tank 108.

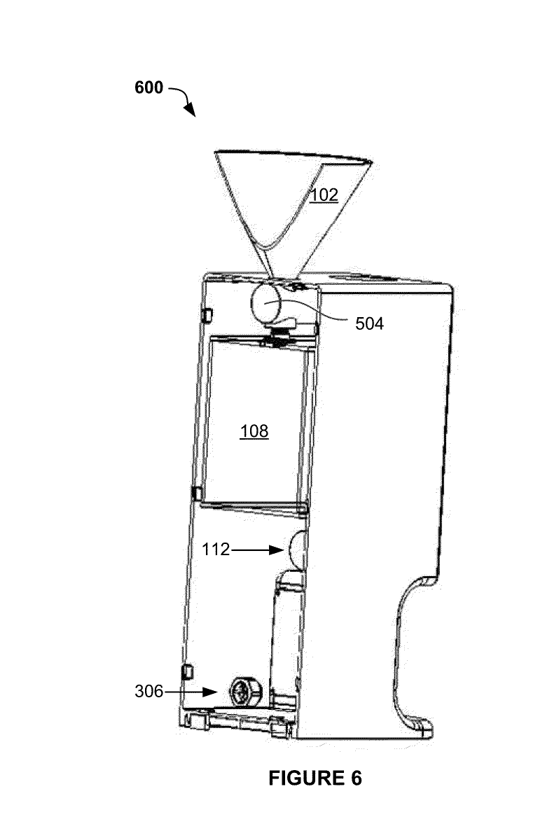

FIG. 6 illustrates a back cross-sectional view 600 of the liquid dispenser 100 in accordance with an implementation of the disclosure. The back cross-sectional view 600 depicts the funnel 102, the fill valve 504, the tank 108, the dispense valve 112, and the electrical connection outlet 306.

FIG. 7 illustrates a side view 700 of the tank 108 including tank level indicators in accordance with an implementation of the disclosure. The side view 700 depicts tank level indicators 116A, 116B, 116C, . . . , 116E, . . . , 116N, and 116X. Fewer or less than tank level indicators than depicted may be provided. The tank level indicators may be collectively referred herein as 116. The tank level indicators 116 may be placed on tank 108 in a manner described above. The tank level indicators 116 may extend further out than depicted on tank 108. In an implementation, the tank level indicators 116 may be placed on more than one side of the tank 108.

As described above, each tank level indicator may be associated with a different pour rate. It may take a longer time to dispense an amount of a liquid when the tank is less full than when the tank is more full (due to gravity, pressure, etc.). Therefore, the liquid may dispense at different rates depending the tank level indicator that is closest to (or falls below) a top level of the liquid. To dispense a liquid that is at a level of a topmost tank level indicator, it may take less time to dispense an amount of liquid (e.g., one ounce) than to dispense the same amount of liquid when the liquid is at the level of a bottommost tank level indicator. Therefore, each tank level indicator may be associated with a different dispense rate.

In an example, suppose that the tank 108 holds two liters or approximately 67.6 ounces. Each tank level indictor in FIG. 7 may be equivalent to approximately 6.7 ounces. Therefore, tank level indicator 116A may be associated with approximately 67.6 ounces, tank level indicator 116B may be associated with 60.9 ounces, and so forth. In an example, if a pour amount is selected as two ounces, the liquid dispenser 100 may pour out two ounces when the fill button 142 is selected. In an implementation, if the liquid dispenser 100 is in a regulated mode, the two conditions described above must be met in order to dispense the liquid.

When 6.7 ounces have been dispensed, the top of the liquid falls from one tank level indicator to a next tank level indicator below it and a new dispense rate and solenoid open time may be applied when dispensing the liquid.

Each tank level indicator may be associated with a respective dispense rate. If dispense rate of the tank level indicator 116B is half an ounce/four seconds, to pour out two ounces when the liquid level is at tank level indicator 116B, it may take sixteen seconds (4×4) to dispense two ounces.

If dispense rate of the tank level indicator 116N is half an ounce/five seconds, to dispense two ounces when the liquid level is at tank level indicator 116N, it may take twenty seconds (5×4) to dispense two ounces.

The ghost button 150 on touchpad input device 130 may an invisible button that may be selected by a user to calibrate, reset or reconfigure certain settings (such as default settings for dispense rates). In an implementation, a user may adjust the dispense rate and/or the solenoid open time based on the liquid to be dispensed. Different liquids may have different viscosities. For example, an alcoholic beverage may have a lower viscosity (and thus higher dispense rate) than cough syrup which may have a higher viscosity (and thus lower dispense rate). In another implementation, a user may adjust the dispense rate in view of an altitude of where the liquid dispenser 100 is located. The altitude may change the barometric pressure of the liquid. The dispense rate may be adjusted based on other factors.

The user may use the ghost button 150 to adjust the dispense rate and/or the solenoid open time. In an implementation, after selecting the ghost button 150, the liquid dispenser 100 may enter into a calibration mode where adjustments to the dispense rate and/or the valve open time may be made. In an implementation, a user may provide two values/rates. One value may be provided for when the tank is 80% full (and the liquid is at a level of the tank level indicator 116C) and the other value may be provided for when the tank is 20% full (and the liquid is at a level of the tank level indicator 116N). As described above, gravity and pressure affects the rate at which a liquid is dispensed such that when there is more liquid in the tank, an amount of the liquid may dispense at a faster rate than when there is less liquid in the tank. Therefore, an amount of a liquid (e.g., one ounce) when the level of the liquid is at 80% full is dispensed at a faster dispense rate than when the same amount of the liquid (e.g., one ounce) is dispensed when the level of the liquid is at 20% full. Additionally, the solenoid may be opened for a shorter period of time when the level of the liquid is at 80% full to dispense the amount of the liquid (e.g., one ounce) than when the level of the liquid is at 20% full to dispense the same amount of the liquid (e.g., one ounce). The remainder of the dispense rates corresponding to the tank level indicators may be calculated from these two values. For example, if a user enters a solenoid open time of three seconds for when the tank is 80% full and nine seconds when the tank is 20% full, the following solenoid open times may be calculated:

One second=100% full (tank level indicator 116A)

Two seconds=90% full (tank level indicator 116B)

Three seconds=80% full (tank level indicator 116N)

Four seconds=70% full

Five seconds=60% full

Six seconds=50% full (tank level indicator 116E)

Seven seconds=40% full

Eight seconds=30% full

Nine seconds=20% full (tank level indicator 116N)

Ten seconds=10% full (tank level indicator 116X)

FIG. 8 illustrates the tank 108 in accordance with an implementation of the disclosure. The tank 108 includes a vent hole 802, a fill valve hole 804, and a dispense valve hole 806. The vent hole 802 provides ventilation on top of the tank 108. The fill valve hole 804 can be coupled to the fill valve 504. The dispense valve hole 806 can be coupled to the dispense valve 112. In an implementation, the periphery of the dispense valve hole 806 may include an optional metal plate (designated by dashed lines). In an implementation, a flange (not shown) may be adhered to the tank 108. The flange may be externally adhered (outside) the tank 108. The dispense valve 112 may thread onto the flange. The flange may be adhered to the tank by glue or other adhesive means. As the flange and the dispense valve 112 are attached externally to the bottom of the tank 108, the liquid may freely dispense out of the tank. When all of the liquid is dispensed, the tank 108 may completely empty.

Display device 106, dispense valve 112, fill valve 504, and touchpad input device 130 may be coupled to a liquid dispensing controller (described herein with respect to FIG. 9), where the liquid dispensing controller controls the display device 106, dispense valve 112, fill valve 504, and the touchpad input device 130.

Referring again to FIGS. 1A, 1B, and 1C, although display device 106 and touchpad input device 130 is depicted as being included in liquid dispenser 100, in other implementations, a display device and/or a touchpad input device may be located external to liquid dispenser 100 and controlled by an external device. For example, liquid dispenser 100 may be controllable by an external device such as a processing device in a mobile device, etc. The external device may connect with liquid dispenser 100 to control the liquid dispenser 100 (including the dispense valve 112 and fill valve 504) via a network. The network may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network) and/or a combination thereof.

Additionally, although in the implementations described above, a user manually inputs a tank level indicator into display device 106, in other implementations, tank 108 may include sensors which may automatically detect the tank level indicators without user input.

FIG. 9 illustrates the schematics 900 of an exemplary liquid dispenser including an exemplary liquid dispensing controller 922 in accordance with an implementation of the disclosure. The schematics 900 include a keypad schematic 902, a valve schematic 906, a display schematic 908, and a mercury switch 910. The schematics 900 include additional schematics. The keypad schematic 902 may be a part of or otherwise coupled to touchpad input device 130. The valve schematic 906 may be coupled to dispense valve 112 and fill valve 504. The display schematic 908 may be a part of or otherwise coupled to the display device 106. The mercury switch 910 may be coupled to fill valve 504. The liquid dispenser may be siphon-protected by the mercury switch 910 which prevents the liquid from being poured out from the top of the tank.

The liquid dispensing controller 922 may receive input signals and provide output signals to the keypad schematic 902, the valve schematic 906, the display schematic 908, and the mercury switch 910.

The user may issue a command to liquid dispensing controller 922. The user may issue a command to fill the tank, program the liquid dispenser 100, dispense liquid out of the tank, set a passcode, set a time, etc. For example, when a user wishes to place the liquid dispenser 100 in a regulated mode, a free flow mode, or a manual mode, the user may provide an input via the touchpad input device 130. The touchpad input device 130 may provide signals to the keypad schematic 902 which provides the signals to the liquid dispensing controller 922. The liquid dispensing controller 922 may issue signals to the display schematic 908 to output to the display device 106. The display device 106 may display queries or other information to the user. For example, the display device 106 may display the following: “Enter new tank level” after the user fills the tank.

The liquid dispensing controller 922 may determine a new tank level associated with the liquid after the solenoid in the dispense valve 112 has opened (and the liquid is dispensed). The liquid dispensing controller 922 may receive signals from valve schematic 906 indicating how long the solenoid was open. The liquid dispensing controller 922 may then subtract the amount of the liquid dispensed at a certain dispense rate from the previous liquid amount (determined based on the tank level of the liquid) to determine a new liquid amount and a new tank level. The liquid dispensing controller 922 may provide an updated dispense rate for dispensing the liquid based on the new tank level.

The liquid dispensing controller 922 may further control a timer and an internal clock.

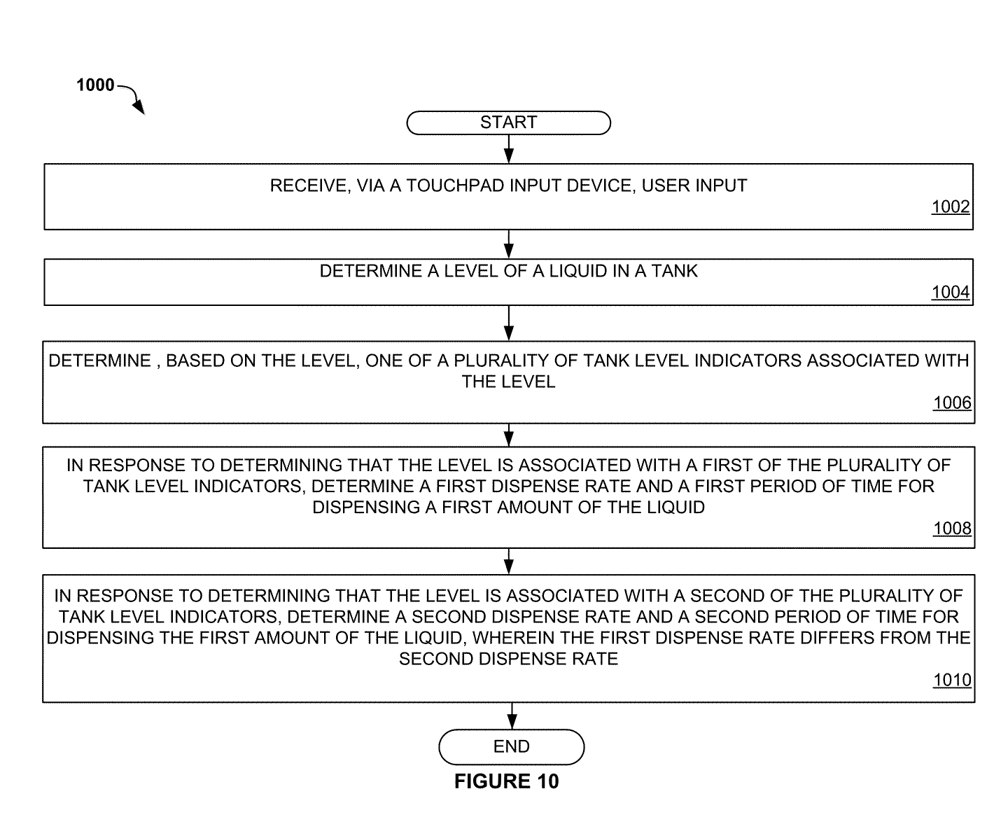

FIG. 10 is a flow diagram illustrating a method 1000 for providing a dispense rate based on a tank level according to an implementation of the disclosure. The method 1000 may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 1000 may be performed by liquid dispensing controller 922 as shown in FIG. 9.

As illustrated, method 1000 begins at block 1002, where the liquid dispensing controller 922 receives, via touchpad input device 130, user input. The user input may be a request to dispense the liquid (e.g., upon selection of the pour button 142).

At block 1004, the liquid dispensing controller 922 determines a level of a liquid in the tank 108. In an implementation, the level is determined in response to receiving user input indicating the level of the tank. The user input may be input by a user using touchpad input device 130. In other implementations, the level may be determined by a sensor or other means.

At block 1006, the liquid dispensing controller 922 determines, based on the level, one of a plurality of tank level indicators associated with the level.

At block 1008, in response to determining that the level is associated with a first of the plurality of tank level indicators, the liquid dispensing controller 922 determines a first dispense rate and a first period of time for dispensing a first amount of the liquid.

At block 1010, in response to determining that the level is associated with a second of the plurality of tank level indicators, the liquid dispensing controller 922 determines a second dispense rate and a second period of time for dispensing the first amount of the liquid. The first dispense rate differs from the second dispense rate.

In an implementation, the user may program the liquid dispenser 100 to enter regulated mode, a free flow mode, or a manual mode. In a free flow mode, the dispensing of the liquid may be limited in view of a liquid amount (e.g., a volume of a liquid per pour such as one ounce per pour). In a regulated mode, the user may provide a request to limit the dispensing of the liquid in view of a dispensing time window, a liquid amount and/or a number of pours. For example, in a regulated mode, the liquid dispenser controller 922 may receive input values from a user for a liquid amount (e.g., one ounce), a dispensing time window (e.g., between 5:00 PM and 7:00 PM), and/or a number of pours (three shots). To enter a regulated mode, the user may input a request to enter the regulated mode (by providing an input via the touchpad input device 130). The request may be received by the liquid dispensing controller 922.

In an implementation, the user may set a passcode for the liquid dispenser 100. The user may provide an input to liquid dispensing controller 922 to set a passcode. The liquid dispensing controller 922 may set the passcode. After the passcode is set, the user may not use the liquid dispenser 100 unless the correct passcode is entered (via touchpad input device 130). If a user inputs an incorrect passcode one or more times, the liquid dispensing controller 922 may remove a pour from the number of pours. For example, if the user is allowed five pours, if the user enters an incorrect passcode, one pour may be subtracted from the allowed pours for each incorrect passcode input. In an implementation, the user may be provided with two chances to enter a correct passcode before a pour is removed.

In an implementation, in a regulated mode, when a drink is dispensed, the solenoid in the fill valve 504 may open. After the drink finishes dispensing, the solenoid closes. The fill valve 504 may provide a signal to the liquid dispensing controller 922 indicating that the solenoid is closed. The liquid dispensing controller 922 may then reset the timer and determine the time remaining until the liquid is available for dispensing (i.e., when the next pour is available). The time remaining until the next pour may be provided on the display device 106.

In an implementation, after a drink has been dispensed, the dispense valve 112 may provide a signal to the liquid dispensing controller 922 indicating that the solenoid was opened and how long the solenoid was opened. The liquid dispensing controller 922 may then subtract the liquid that was dispensed (based on the dispense rate of the liquid) from a calculation of the liquid amount prior to dispensing to determine the new liquid amount and the corresponding tank level and tank level indicator. The liquid dispensing controller 922 may instruct the timer to reset.

In an implementation, when the liquid dispensing controller 922 determines that a predetermined amount of the liquid has been dispensed out, the top level of the tank may fall to a third tank level. The liquid dispensing controller 922 may then determine that a new, updated level that is associated with the new liquid amount.

Liquid dispenser 100 may be used by users to limit or restrict their intake of a liquid for various reasons. For example, a person may purchase a fixed amount of an alcoholic beverage to consume over a period of time (i.e., a week). In another example, a person may have dietary, medical or other restrictions on the amount of liquid he/she can consume. In yet another example, a medical professional may prescribe a fixed amount of the liquid for a patient. For example, a doctor may instruct a patient to consume a maximum of five alcoholic drinks in a week. In another example, an individual may wish to lock out others (such as children) from accessing the liquid dispenser. In another example, an individual may decrease his/her dependency on a substance in a time-controlled manner. The individuals may use the liquid dispenser 100 for a variety of reasons.

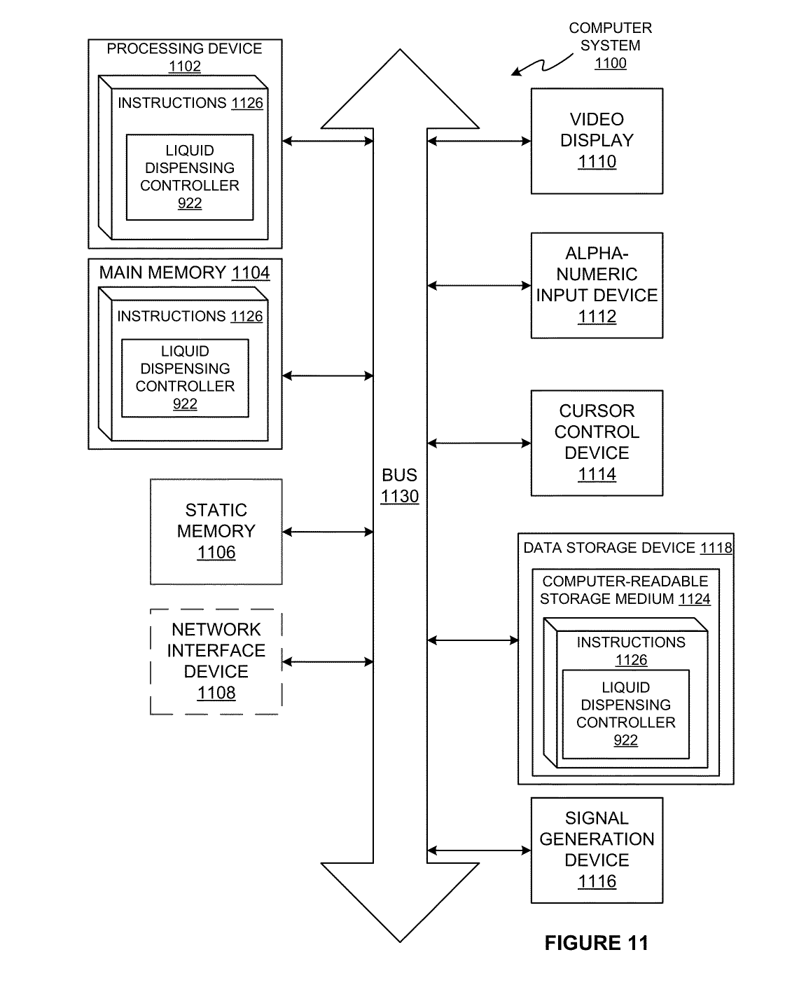

FIG. 11 illustrates a diagrammatic representation of a machine in the exemplary form of a computer system 1100 within which a set of instructions, for causing the machine to perform any one or more of the methodologies discussed herein, may be executed. The exemplary computer system 1100 includes a processing device (processor) 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a data storage device 1118, which communicate with each other via a bus 1130.

Processor 1102 represents one or more general-purpose processing devices such as a microprocessor, central processing unit, or the like. More particularly, the processor 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1102 may also be one or more special-purpose processing devices such as an application specific integrated circuit (ASIC), a field programmable gate array (FPGA), a DSP, network processor, or the like. The processor 1102 is configured to execute instructions 1126 for performing the operations and steps discussed herein.

The computer system 1100 may further include a network interface device 1122. The computer system 1100 also may include a video display unit 1110 (e.g., an LCD, a cathode ray tube (CRT), or a touch screen), an alphanumeric input device 1112 (e.g., a keyboard), a cursor control device 1114 (e.g., a mouse), and a signal generation device 1120 (e.g., a speaker).

The data storage device 1118 may include a computer-readable storage medium 1124 on which is stored one or more sets of instructions 1126 (e.g., software) embodying any one or more of the methodologies or functions described herein. The instructions 1126 may also reside, completely or at least partially, within the main memory 1104 and/or within the processor 1102 during execution thereof by the computer system 1100, the main memory 1104 and the processor 1102 also constituting computer-readable storage media.

The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 1100 may be utilized by or illustrative of one or more of liquid dispenser 100 or liquid dispenser controller 922.

The instructions 1126 may further be transmitted or received over a network (not depicted) via an optional network interface device 1108.

The computer-readable storage medium 1124 may also be used to store instructions 1126 to implement liquid dispensing controller 922 (described with respect to FIG. 9) to provide a dispense rate for dispensing a liquid in a system such as the liquid dispenser 100 described with respect to FIGS. 1A-1C, 2A, 2B, 3A, 3B, 4-8. The computer-readable storage medium 1124 may also be used to store instructions to determine and provide a dispense rate based on a tank level according to implementations of the disclosure, as described herein. While the computer-readable storage medium 1124 is shown in an exemplary implementation to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “transmitting”, “generating”, “adding”, “subtracting”, “inserting”, “removing”, “analyzing”, “determining”, “enabling”, “identifying”, “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus, device, or system for performing the operations herein. This apparatus, device, or system may be specially constructed for the required purposes, or it may include a general purpose computer selectively activated or reconfigured by a computer program stored in the computer. Such a computer program may be stored in a computer- or machine-readable storage medium, such as, but not limited to, any type of disk including floppy disks, optical disks, compact disk read-only memories (CD-ROMs), and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an implementation” or “one implementation” means that a particular feature, structure, or characteristic described in connection with the implementation is included in at least one implementation. Thus, the appearances of the phrase “an implementation” or “one implementation” in various places throughout this specification are not necessarily all referring to the same implementation.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A liquid dispensing apparatus comprising:
a tank configured to dispense a liquid, the tank comprising:
an opening configured to receive the liquid; and
a dispense valve configured to dispense the liquid out of the tank;
a touchpad input device configured to receive an input from a user; and
a liquid dispensing controller configured to determine a dispense rate for dispensing the liquid based on the input received from the user,
wherein the liquid dispensing apparatus, via the dispense valve, is configured to dispense the liquid at a first dispense rate for a first period of time when a level of the liquid in the tank falls below a first tank level to dispense a first amount of the liquid and to dispense the liquid at a second dispense rate for a second period of time when the level of the liquid in the tank falls below a second tank level to dispense the first amount of the liquid, and wherein the first dispense rate differs from the second dispense rate.

2. The liquid dispensing apparatus of claim 1, wherein the tank further comprises a fill valve coupled to the opening, the opening to receive a funnel for input of the liquid to the tank.

3. The liquid dispensing apparatus of claim 1, further comprising a display device configured to display a time remaining until the liquid is available for dispensing.

4. The liquid dispensing apparatus of claim 3, wherein the touchpad input device is coupled to the display device and comprises a plurality of keys.

5. The liquid dispensing apparatus of claim 4, wherein the display device is to provide a display based on the input received by the touchpad input device.

6. The liquid dispensing apparatus of claim 1, further comprising an indicator light to indicate whether the liquid is available for dispensing.

7. The liquid dispensing apparatus of claim 1, further comprising a cavity base located underneath the dispense valve, wherein the liquid is dispensed within the cavity base.

8. A method comprising:
receiving, by a processor, via a touchpad input device, user input;
determining a level of a liquid in a tank;
determining, based on the level, one of a plurality of tank level indicators associated with the level;
in response to determining that the level is associated with a first tank level of the plurality of tank level indicators, determining, by the processor, a first dispense rate and a first period of time for dispensing a first amount of the liquid; and
in response to determining that the level is associated with a second tank level of the plurality of tank level indicators, determining, by the processor, a second dispense rate and a second period of time for dispensing the first amount of the liquid, wherein the first dispense rate differs from the second dispense rate.

9. The method of claim 8, further comprising resetting a timer in response to receiving an indication that a solenoid in a dispense valve has opened to dispense the liquid.

10. The method of claim 8, wherein the determining the level of the liquid in the tank is in response to receiving the level of the tank input by the touchpad device.

11. The method of claim 8, further comprising providing for display on a display device a time remaining until the liquid is available for dispensing.

12. The method of claim 8, further comprising:
determining that a predetermined amount of the liquid has dispensed; and
determining an updated level associated with a third tank level of the plurality of tank level indicators in response to the determining that the predetermined amount of the liquid has dispensed.

13. The method of claim 8, wherein the liquid comprises one of an alcoholic beverage or a prescription medication.

14. The method of claim 8, wherein the user input comprises a request to dispense the liquid.

15. The method of claim 8, further comprising:
receiving a request to limit the dispensing of the liquid in view of at least one of a dispensing time window, a liquid amount, or a number of pours.

16. The method of claim 15, further comprising:
receiving user input to set a first passcode;
setting the first passcode;
receiving user input comprising a second passcode, wherein the second passcode is different than the first passcode; and
removing a pour from the number of pours in response to receiving the user input comprising the second passcode.

17. A non-transitory computer-readable storage medium storing instructions which, when executed, cause a processing device to perform operations comprising:
receiving, by a processor, via a touchpad input device, user input;
determining a level of a liquid in a tank;
determining, based on the level, one of a plurality of tank level indicators associated with the level;
in response to determining that the level is associated with a first tank level of the plurality of tank level indicators, determining, by the processor, a first dispense rate and a first period of time for dispensing a first amount of the liquid; and
in response to determining that the level is associated with a second tank level of the plurality of tank level indicators, determining, by the processor, a second dispense rate and a second period of time for dispensing the first amount of the liquid, wherein the first dispense rate differs from the second dispense rate.

18. The non-transitory computer-readable storage medium of claim 17, wherein the operations further comprise providing for display on a display device a time remaining until the liquid is available for dispensing.

19. The non-transitory computer-readable storage medium of claim 17, wherein the operations further comprise receiving a request to limit the dispensing of the liquid in view of at least one of a dispensing time window, a liquid amount, or a number of pours.

20. The non-transitory computer-readable storage medium of claim 19, wherein the operations further comprise:
receiving user input to set a first passcode;
setting the first passcode;
receiving user input comprising a second passcode, wherein the second passcode is different than the first passcode; and
removing a pour from the number of pours in response to receiving the user input comprising the second passcode.
